(19) United States
(12) Patent Application Publication
(10) Pub. No.: US 2022/0350777 A1
(43) Pub. Date: Nov. 3, 2022

(54) DOCUMENT SEARCH SYSTEM, DOCUMENT SEARCH METHOD, AND COMPUTER-READABLE STORAGE MEDIUM

(71) Applicant: KONICA MINOLTA, INC., Tokyo (JP)

(72) Inventor: Kenya HABA, Toyokawa-shi (JP)

(73) Assignee: KONICA MINOLTA, INC., Tokyo (JP)

(21) Appl. No.: 17/721,486

(22) Filed: Apr. 15, 2022

(30) Foreign Application Priority Data
Apr. 30, 2021 (JP) 2021-077007

(51) Int. Cl. G06F 16/14; G06F 16/16; G06F 16/182; G06F 16/13

(52) U.S. Cl. CPC G06F 16/148; G06F 16/168; G06F 16/183; G06F 16/13; G06F 16/156

(57) ABSTRACT

A document search system allowing a user to easily and intuitively designate a search condition including a feature amount of a document is provided. The document search system searches for at least one document stored in a file server by referring to at least one index including a feature amount relating to at least one object included in each of the at least one document stored in the file server. The document search system searches for the document matched with the search condition from among the at least one document stored in the file server by referring to the search condition including disposition information about at least one symbol on the virtual page and the at least one index.

The entire disclosure of Japanese Patent Application No. 2021-077007, filed on Apr. 30, 2021, is incorporated herein by reference in its entirety.

### BACKGROUND

### Technological Field

The present disclosure relates to a document search system, and more specifically, to a document search system using a feature amount of a document.

### Description of the Related Art

A search system that searches for an arbitrary electronic document from electronic documents stored in a storage such as a file server based on the feature amount of the electronic document is known. For example, the feature amount of the electronic document includes a size, a color, a shape, and the like of a graph, a table, and the like. Furthermore, a technique in which such a search system and a multifunction peripheral (M P) are combined has also been developed.

Relating to the search for an image of the document, for example, Japanese Laid-Open Patent Publication No. 2006-163841 discloses “Image search device for searching for image similar to search image from registered images”, and this image search device is “an image search device including a region division unit that extracts a plurality of partial regions constituting an image, a region feature extraction unit that calculates the number of partial regions and a barycentric position, and a feature amount update unit that stores the calculated number of partial regions and the barycentric position as an index in an image region management DB, wherein a partial region matched with the number of partial regions and the barycentric position of a search image is read from the image region management DB into a memory, registered images are narrowed down based on the read partial region, and the image is searched for the narrowed registered images”. (see [Summary]).

Furthermore, for example, another technique relating to the image search is disclosed in National Patent Publication No. 2013-509660.

### SUMMARY

According to the techniques disclosed in Japanese Laid-Open Patent Publication No. 2006-163841 and National Patent Publication No. 2013-509660, the user cannot easily and intuitively designate the search condition including the feature amount of the document. Accordingly, there is a need for a technique for allowing the user to easily and intuitively designate the search condition including the feature amount of the document.

The present disclosure has been made in view of the above background, and an object in one aspect is to provide the technique for the user to easily and intuitively designate the search condition including the feature amount of the document.

According to an embodiment, a document search system is provided. To achieve at least one of the abovementioned objects, according to an aspect of the present invention, a document search system reflecting one aspect of the present invention comprises a storage that stores at least one index. Each of the at least one index includes a feature amount relating to at least one object included in each of at least one document stored in a file server. The document search system further includes a controller that refers to the at least one index to search for the at least one document stored in the file server. The controller causes a terminal to display a search screen, the search screen having a function for disposing each of at least one symbol associated with each of a type of the at least one object on a virtual page representing the document, and searches for a document matched with a search condition from among at least one document stored in the file server by referring to the search condition including disposition information about the at least one symbol on the virtual page and the at least one index based on an operation of the search screen.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a view illustrating a search screen 100 of a document search system according to an embodiment.

FIG. 2 is a view illustrating an example of a document search system 200 of the embodiment.

FIG. 3 is a view illustrating an example of a function of a search server 210 of the embodiment.

FIG. 4 is a view illustrating an example of a hardware configuration of an information processing device 400 of the embodiment.

FIG. 5 is a view illustrating an example of an index 510 of the embodiment.

FIG. 6 is a view illustrating a first example of a function of the document search system 200.

FIG. 7 is a view illustrating a second example of the function of the document search system 200.

FIG. 8 is a view illustrating a third example of the function of the document search system 200.

FIG. 9 is a view illustrating a fourth example of the function of the document search system 200.

FIG. 10 is a view illustrating a fifth example of the function of the document search system 200.

FIG. 11 is a view illustrating a sixth example of the function of the document search system 200.

FIG. 12 is a view illustrating a seventh example of the function of the document search system 200.

FIG. 13 is a view illustrating an eighth example of the function of the document search system 200.

FIG. 14 is a view illustrating a ninth example of the function of the document search system 200.

FIG. 15 is a view illustrating a tenth example of the function of the document search system 200.

FIG. 16 is a view illustrating an eleventh example of the function of the document search system 200.

FIG. 17 is a view illustrating a twelfth example of the function of the document search system 200.

FIG. 18 is a view illustrating a thirteenth example of the function of the document search system 200.

FIG. 19 is a view illustrating a fourteenth example of the function of the document search system 200.

FIG. 20 is a view illustrating a fifteenth example of the function of the document search system 200.

FIG. 21 is a flowchart illustrating an example of processing of generating the index 510 by the search server 210.

FIG. 22 is a flowchart illustrating an example of search processing by the search server 210 and a terminal 220.

### DETAILED DESCRIPTION OF EMBODIMENT

Hereinafter, one or more embodiments of the present invention will be described with reference to the drawings. However, the scope of the invention is not limited to the disclosed embodiments. In the following description, the same component is denoted by the same reference numeral. Those names and functions are the same. Accordingly, the detailed description thereof will not be repeated.

### A. Application Example

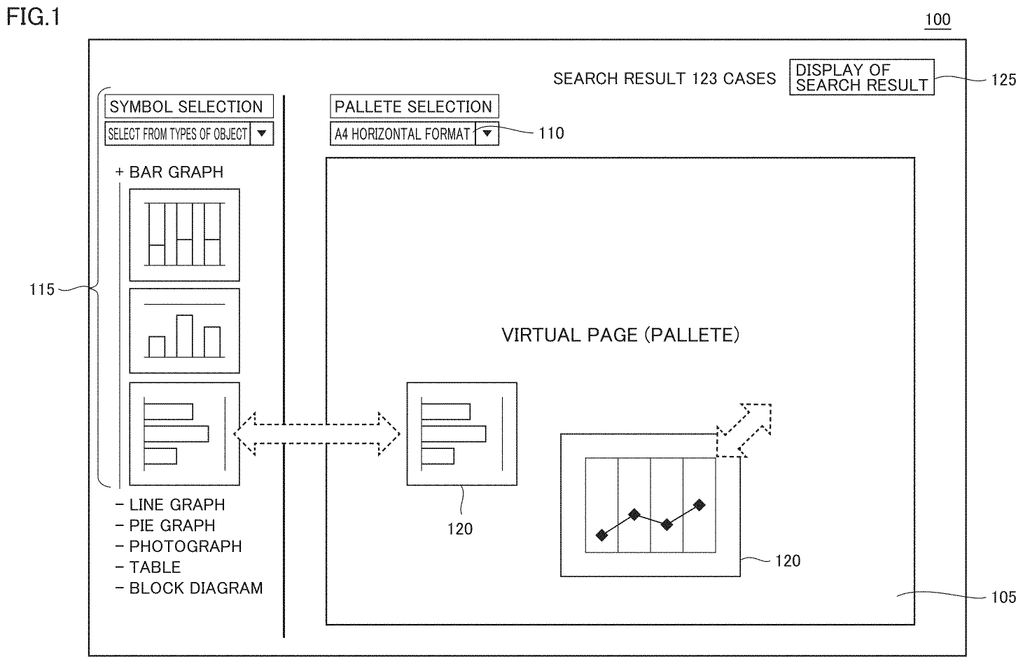

FIG. 1 is a view illustrating a search screen 100 of a document search system according to an embodiment. With reference to FIG. 1, an outline of search screen 100 and search processing in the document search system of the embodiment will be described. Hereinafter, the electronic document is simply referred to as a document. The document can include text, graphs, tables, figures, pictures, any other multimedia information, and the like.

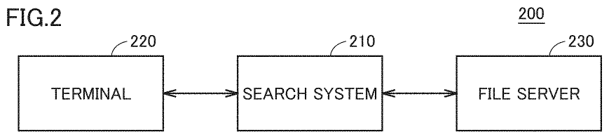

A document search system 200 (see FIG. 2) of the embodiment can be constructed on a web server or a cloud environment. Document search system 200 includes a search server 210 (see FIG. 2). In one aspect, document search system 200 may further include a file server 230 (see FIG. 2). In another aspect, document search system 200 may further include file server 230 and a user's terminal 220 (hereinafter, referred to as “terminal 220”).

Search server 210 distributes search screen 100 to terminal 220 based on reception of a request from terminal 220. For example, the user can display search screen 100 distributed from search server 210 to terminal 220 on the display using a browser function of terminal 220. In addition, the user can search for the document using search screen 100. In one aspect, terminal 220 may be any other information processing device such as a PC, a smartphone, a tablet, or the like.

Search screen 100 distributed from search server 210 to terminal 220 may be a screen written in a hypertext markup language (HTML) or the like. In one aspect, terminal 220 may use a search screen of a dedicated client application instead of distributed search screen 100. In this case, terminal 220 can download the client application from a predetermined server or the like. In addition, the client application includes all functions such as search screen 100 described below.

(a. Configuration of Search Screen 100)

A main configuration of search screen 100 will be described. Search screen 100 is a screen searching for at least one document stored on file server 230. The user defines the feature amount of the searched document on search screen 100. The feature amount is information such as disposition, a color, and a size of a figure, a graph, a table, and other arbitrary objects in a document. The user expresses an image of the document in a mind on a virtual page 105 of search screen 100. Document search system 200 searches for the document in file server 230 based on the feature amount of the document expressed on virtual page 105.

As an example, search screen 100 includes virtual page 105 called a palette, a palette selection user interface (UI) part 110 in which the user selects or inputs a size of the virtual page, a symbol selection UI part 115 in which the user selects a symbol 120, and a search result display button 125. For example, these configurations include a combination of Javascript (registered trademark), an HTML UI part, or a combination of the HTML UI parts.

Virtual page 105 is a page imitating the document of the search target. In one aspect, search screen 100 may display virtual page 105 having a default size in an initial state.

Palette selection UI part 110 is a UI part determining the size of virtual page 105. For example, palette selection UI part 110 includes a set of arbitrary UI parts such as a pull-down and an input form. The user can select virtual page 105 having any size such as A4 through palette selection UI part 110. In one aspect, the user may input an arbitrary size (vertical and horizontal sizes) to palette selection UI part 110 to display virtual page 105 having the desired size on search screen 100.

The user disposes desired symbol 120 on virtual page 105 from symbol selection UI part 115. Symbol 120 is an image imitating a diagram, a graph, a table, and any other object disposed in the document. Each symbol 120 is associated with an object type (graphs, tables, and the like). Search server 210 stores the associated information between each symbol 120 and the type of each object. For example, the “associated information between each symbol 120 and the type of each object” may be meta information such as a tag. The user disposes symbol 120 imitating the object on virtual page 105, whereby the user can faithfully and easily represent the document which the user have envisioned in own mind. In one aspect, the user may dispose symbol 120 on virtual page 105 by an operation such as dragging and dropping.

Symbol selection UI part 115 displays all or some of symbols 120. For example, symbol selection UI part 115 includes an arbitrary UI part such as a pull-down or an input form or a set of UI parts. In one aspect, symbol selection UI part 115 may display symbols 120 in units of groups. In this case, as an example, the user selects the type (group name) or the like of symbol 120 from pull-down or the like, whereby at least one symbol 120 belonging to a desired group can be displayed on search screen 100.

In another aspect, symbol selection UI part 115 may have a function for registering a new group based on a user's operation. The user operates symbol selection UI part 115 to define a group including at least one symbol 120. The information about the newly produced group may be transmitted to search server 210. In this way, search server 210 can transmit search screen 100 including the information about the newly produced group to terminal 220 from the next time.

Search result display button 125 is a button switching search screen 100 to a search result screen. In one aspect, search screen 100 may transition to the search result screen based on press of search result display button 125. In another aspect, a part of search screen 100 may be updated without causing screen transition based on the press of search result display button 125, and the search result may be displayed at the updated location.

(b. Internal Operation of Document Search System)

An internal operation of document search system 200 will be described below. Part or all of the processing of terminal 220 described below may be implemented by terminal 220 using a function (program such as Javascript) of search screen 100.

First, in a first step, search server 210 distributes search screen 100 to terminal 220 based on reception of a request to acquire search screen 100 from terminal 220.

In a second step, terminal 220 receives the user's operation and disposes at least one symbol 120 on virtual page 105. In one aspect, terminal 220 may change the color, the size, the position, and the like of symbol 120 disposed on virtual page 105 based on the operation from the user. In another aspect, terminal 220 may record the time required for the user to dispose symbol 120 on virtual page 105 for each symbol.

In a third step, terminal 220 generates a search condition (hereinafter, the search condition of the document may be simply referred to as a “search condition”) of the document based on at least one symbol 120 disposed on virtual page 105 based on reception of a trigger of search execution from the user (for example, based on the press of search result display button 125).

The “search condition” includes a setting item of at least one symbol 120. For example, it is assumed that a first symbol and a second symbol are disposed on virtual page 105. In this case, the search condition includes the setting item of the first symbol and the setting item of the second symbol as a parameter. The “setting item for each symbol” includes arbitrary items such as the type, the position, the size, and the color of symbol 120. The position and the size of symbol 120 may be relative values with respect to virtual page 105.

In one aspect, the search condition may also include the size of virtual page 105. In another aspect, the search condition may include change information about the setting item (the type, the color, the size, the position, and the like) of symbol 120. In another aspect, the search condition may include the time required for the user to dispose each symbol 120 on virtual page 105 for each symbol 120.

In a fourth step, terminal 220 transmits the search conditions to search server 210. The search condition can include the setting item of each symbol 120 disposed on virtual page 105 and the size of virtual page 105.

In a fifth step, search server 210 searches file server 230 based on the received search condition and a search index (hereinafter referred to as an “index”).

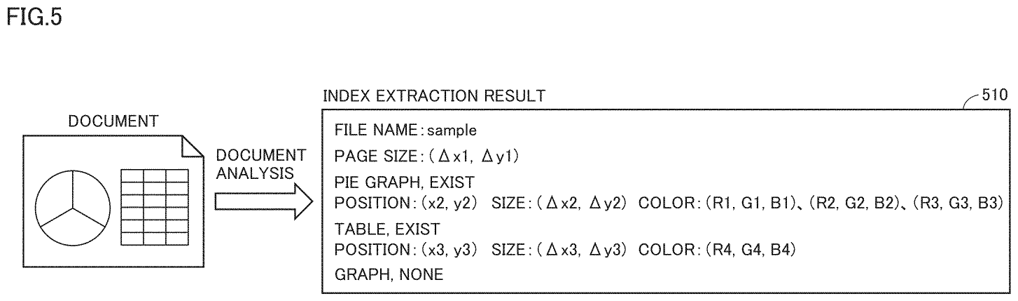

Search server 210 stores an index 510 (see FIG. 5) for searching the document. “Index 510” includes the feature amount of each document and is used for searching the document. The “feature amount” of the document is an arbitrary item such as the type, the position, the size, and the color of at least one object (any object such as a figure or a graph) disposed on the document, and corresponds to the setting item of each symbol in the search condition. In one aspect, one index may include the feature amount of one document. In another aspect, one index may include feature amounts of a plurality of documents.

Search server 210 can compare the search condition with each of the at least one index to search for the document matched with the search condition. More specifically, search server 210 individually compares the setting item of each symbol 120 included in the search condition with the item of each object included in each of the at least one index.

Search server 210 compares the search condition with each of the at least one index to calculate a degree of similarity of the document. The “degree of similarity” is a score indicating how much the searched document coincides with the search condition. In other words, the degree of similarity indicates how the searched document is similar to a document produced by the user placing at least one symbol 120 on virtual page 105.

Search server 210 may select the plurality of documents having the high degree of similarity as the document corresponding to the search condition. Search server 210 can calculate the degree of similarity between the document and the search condition and sort the plurality of documents in descending order of the degree of similarity. Details of the search condition and the calculation of the degree of similarity will be described later.

In a sixth step, search server 210 transmits the search result to terminal 220. When at least one document that corresponds to the search condition exists, the search results can include thumbnails of the at least one document. When the document that corresponds to the search condition does not exist, the search result includes the information indicating that the document is not found.

In a seventh step, terminal 220 displays the received search result on search screen 100. In one aspect, terminal 220 may transition search screen 100 to a screen displaying the search result. In another aspect, terminal 220 may update a part of search screen 100 to display the search result in search screen 100 without transitioning search screen 100.

In an eighth step, terminal 220 acquires the document by transmitting the document acquisition request to search server 210 based on the reception of the operation for acquiring the document included in the search result from the user. In one aspect, terminal 220 may directly acquire the document from file server 230.

### B. Configuration of Document Search System

With reference to FIGS. 2 to 5, a function of document search system 200, a hardware configuration of each device, and an index will be described below.

FIG. 2 is a view illustrating an example of document search system 200 of the embodiment. Document search system 200 includes search server 210, terminal 220, and file server 230. In one aspect, document search system 200 may not include terminal 220. In another aspect, document search system 200 may not include terminal 220 and file server 230. In another aspect, search server 210 and file server 230 may be one device.

File server 230 stores at least one document. Search server 210 stores the index of each of at least one document stored in file server 230, and provides the function for searching for the document in file server 230 to terminal 220. In one aspect, search server 210 can generate the new index or update the index based on addition of the new document to file server 230 or the update of the document on file server 230.

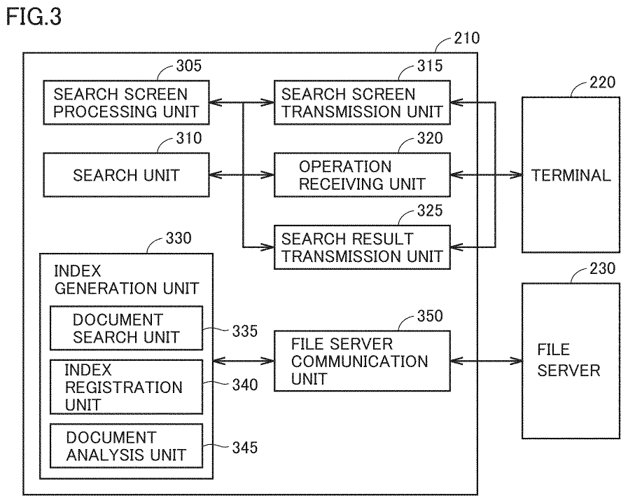

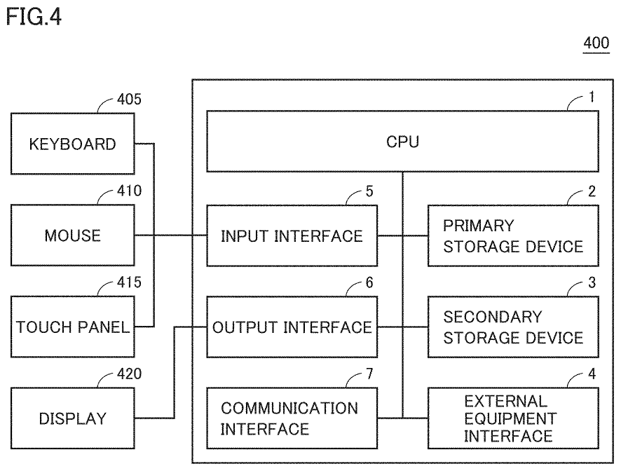

FIG. 3 is a view illustrating an example of a function of search server 210 of the embodiment. In one aspect, each function of search server 210 in FIG. 3 may be implemented as a program. In this case, each function of search server 210 can be executed on the hardware in FIG. 4.

Search server 210 includes a search screen processing unit 305, a search unit 310, a search screen transmission unit 315, an operation reception unit 320, a search result transmission unit 325, an index generation unit 330, and a file server communication unit 350 as main functions.

Search screen processing unit 305 executes processing of generating search screen 100, server-side processing when receiving the request from search screen 100, and the like. As an example, search screen processing unit 305 may distribute a list of the grouped symbols 120 and data necessary for drawing search screen 100.

Search unit 310 manages an overall flow of the search processing using the feature amount of the document. For example, by outputting an instruction to another functional unit, search unit 310 can execute processing such as acquisition of the search condition, extraction of the feature amount, reference to the document in file server 230, and output of the search result.

Search screen transmission unit 315 transmits search screen 100 and data (symbol 120, the UI part, the text message, and the like) used by search screen 100 to terminal 220.

Operation reception unit 320 acquires the search condition from terminal 220. The search condition includes the feature amount of the document or information (information such as sizes, shapes, positions, colors, and the like of figures, graphs, tables, and the like included in documents, and information such as fonts and decorations of texts) extracting the feature amount. Terminal 220 generates the search condition based on the disposition of each symbol 120 on virtual page 105, a change content of the setting item of each symbol 120, and the like.

In one aspect, operation reception unit 320 may transmit search screen 100 to terminal 220. In another aspect, operation reception unit 320 may acquire the search condition from terminal 220 through a dedicated client application.

Search result transmission unit 325 transmits the search result to terminal 220. In one aspect, the search result includes information about one or the plurality of documents corresponding to the search condition. In one aspect, the search result may include thumbnails of one or the plurality of documents corresponding to the search condition.

Index generation unit 330 includes a document search unit 335, an index registration unit 340, and a document analysis unit 345. Document search unit 335 searches for the document matched with the search condition by referring to the index stored in search server 210.

Index registration unit 340 can generate the index of the document newly added to file server 230 and store (register) the generated index in search server 210. In one aspect, when the document on file server 230 is updated, index registration unit 340 may update the index of the updated document. In another aspect, index registration unit 340 can also generate the thumbnail of the document. Index registration unit 340 can store the generated thumbnail in search server 210 while associating the thumbnail with the index.

Document analysis unit 345 analyzes the document acquired from file server 230 and extracts the feature amount (for example, sizes, colors, shapes, and the like of graphs, tables, and the like) of the document. These feature amounts are registered in the index.

File server communication unit 350 communicates with file server 230. File server communication unit 350 accesses file server 230 based on the reception of the search request from terminal 220 by search server 210. In one aspect, file server communication unit 350 may periodically communicate with file server 230 to acquire the newly added document or the updated document in order to update the index.

FIG. 4 is a view illustrating an example of a hardware configuration of an information processing device 400 of the embodiment. Search server 210, terminal 220, and file server 230 can be implemented by at least one information processing device 400. In one aspect, search server 210, terminal 220, and file server 230 may not include a part of the configuration in FIG. 4 as necessary. For example, search server 210 and file server 230 may not include a mouse 410, a touch panel 415, and the like.

Information processing device 400 includes a central processing unit (CPU) 1, a primary storage device 2, a secondary storage device 3, an external equipment interface 4, an input interface 5, an output interface 6, and a communication interface 7.

CPU 1 can execute a program implementing various functions of information processing device 400. CPU 1 is constructed with at least one integrated circuit. For example, the integrated circuit may include at least one CPU, at least one field programmable gate array (FPGA), or a combination thereof.

Primary storage device 2 stores the program executed by CPU 1 and data referred to by CPU 1. In one aspect, primary storage device 2 may be implemented a dynamic random access memory (DRAM), a static random access memory (SRAM), or the like.

Secondary storage device 3 is a nonvolatile memory, and may store the program executed by CPU 1 and the data referred to by CPU 1. In this case, CPU 1 executes the program read from secondary storage device 3 to primary storage device 2, and refers to the data read from secondary storage device 3 to primary storage device 2. In one aspect, secondary storage device 3 may be implemented by a hard disk drive (HDD), a solid state drive (SSD), an erasable programmable read only memory (EPROM), an electrically erasable programmable read only memory (EEPROM), a flash memory, or the like.

External equipment interface 4 can be connected to any external equipment such as a printer, a scanner, and an external HDD. In one aspect, external equipment interface 4 may be implemented by a universal serial bus (USB) terminal or the like.

Input interface 5 can be connected to any input device such as a keyboard 405, a mouse 410, a touch panel 415, or a game pad. In one aspect, input interface 5 may be implemented by a USB terminal, a PS/2 terminal, a Bluetooth (registered trademark) module, and the like.

Output interface 6 can be connected to any output device such as a display 420 (a cathode ray tube display, a liquid crystal display, an organic electro-luminescence (EL) display, or the like). In one aspect, output interface 6 may be implemented by a USB terminal, a D-sub terminal, a digital visual interface (DVI) terminal, a high-definition multimedia interface (HDMI) (registered trademark) terminal, or the like.

Communication interface 7 is connected to a wired or wireless network device. In one aspect, communication interface 7 may be implemented by a local area network (LAN) port, a wireless fidelity (Wi-Fi) (registered trademark) module, or the like. In another aspect, communication interface 7 may transmit and receive data using a communication protocol such as a transmission control protocol/internet protocol (TCP/IP) or a user datagram protocol (UDP).

FIG. 5 is a view illustrating an example of index 510 of the embodiment. Search server 210 may generate or update index 510 based on the reception of the new document or the updated document from terminal 220. In addition, search server 210 can generate or update index 510 based on the detection of the addition or the update of the document on file server 230.

Index 510 includes the feature amount of the document. As an example, the feature amount of the document may include a file name, a page size, and an arbitrary item such as a position, a size, and a color of an arbitrary object such as a graph, a diagram, and a table. Search server 210 generates index 510 for each document and stores index 510 in secondary storage device 3 (index database). The object included in index 510 corresponds to symbol 120 included in the search condition. The item of the object corresponds to the setting item of symbol 120.

When receiving the search condition of the document from terminal 220, search server 210 extracts the setting item for each symbol 120 from the search condition. Subsequently, search server 210 compares the extracted setting item for each symbol 120 with the item (feature amount) for each object included in each index 510 to search for the document matched with the search condition. In search server 210, other arbitrary information such as the size of the document included in the search condition can be also used for searching for the document.

### C. Function of Document Search System

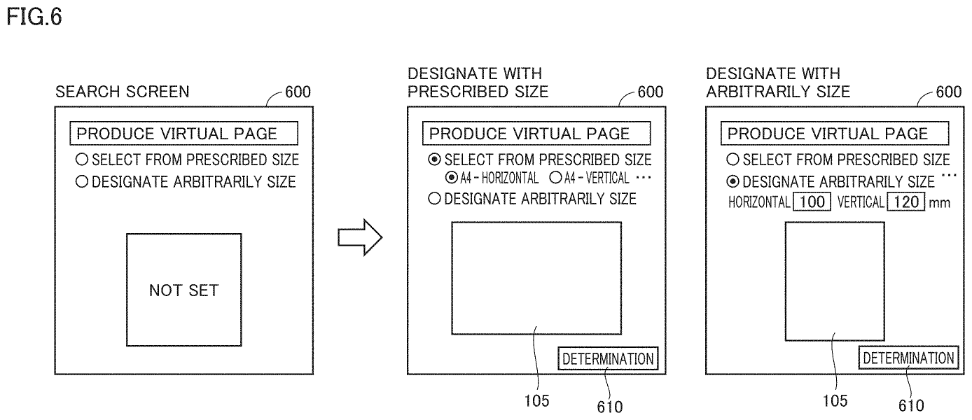

With reference to FIGS. 6 to 20, variations of the search screen and functions of document search system 200 will be described below. In one aspect, the terminal 220 may cause screens to be displayed on the display to mutually transition between screens illustrated in FIG. 1 and subsequent drawings based on an operation by the user. In another aspect, each screen illustrated in the following drawings may be a part or a variation of search screen 100. The user can set the search condition by appropriately combining the functions of the search screens in FIG. 1 and subsequent drawings.

FIG. 6 is a view illustrating a first example of a function of document search system 200. A search screen 600 is a screen setting the size of virtual page 105. The user may select a desired size of virtual page 105 from a prescribed size such as A4 using search screen 600, or determine the size of virtual page 105 by inputting the vertical and horizontal sizes of virtual page 105 to search screen 600. In one aspect, after the size of the virtual page 105 is determined (such as after a determination button 610 is pressed), the screen displayed on the display of terminal 220 can transition from search screen 600 to another screen such as search screen 100.

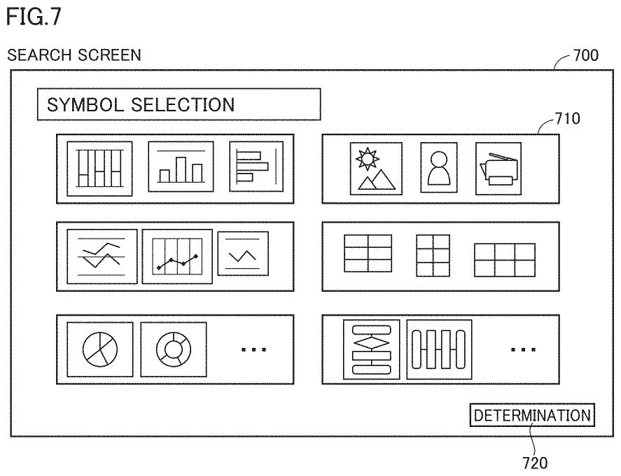

FIG. 7 is a view illustrating a second example of the function of document search system 200. A search screen 700 is a screen selecting symbol 120. The user can switch symbol 120 displayed on search screen 100 or the like by selecting a symbol group 710. In one aspect, after symbol group 710 is selected (such as after an enter button 720 is pressed), the screen displayed on the display of terminal 220 can transition from search screen 700 to another screen such as search screen 100.

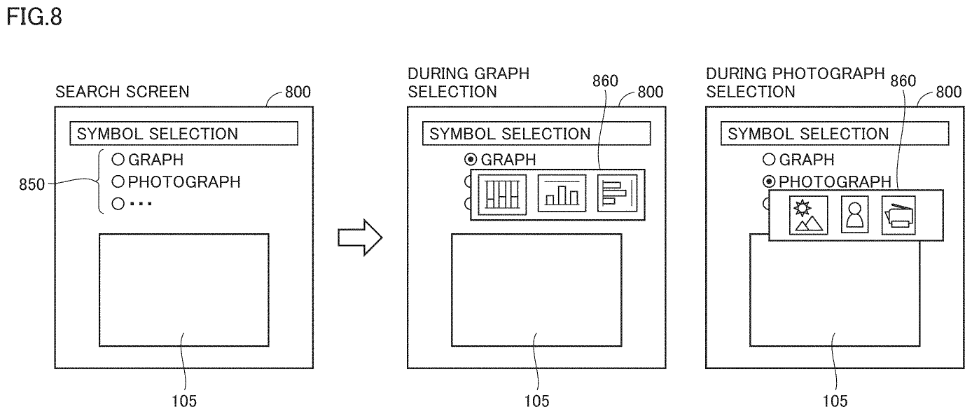

FIG. 8 is a view illustrating a third example of the function of document search system 200. A search screen 800 is a screen selecting symbol 120. Unlike search screen 700, search screen 800 includes a radio button 850 selecting the type of symbol 120. The user switches a group 860 of the displayed symbol by radio button 850. In one aspect, search screen 800 may be a variation of search screen 100. In another aspect, search screen 800 and search screen 100 can transition to each other.

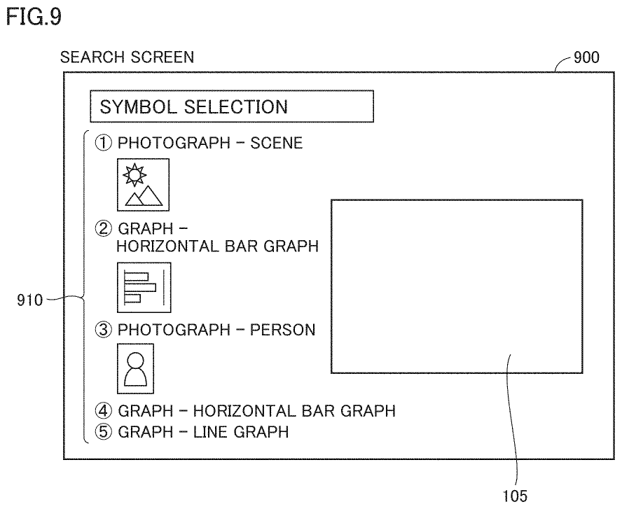

FIG. 9 is a view illustrating a fourth example of the function of document search system 200. A search screen 900 displays a list 910 of symbols frequently used based on a selection history of past symbols 120. Alternatively, search screen 900 may display the group including symbol 120 that is frequently used.

Search server 210 may count and store the number (use frequency) of each symbol 120 included in the past search request. In this case, for example, search server 210 can transmit information relating to the use frequency of each symbol 120 to terminal 220. Search screen 900 can display list 910 of symbols having the high use frequency based on the information relating to the use frequency of each symbol 120. In one aspect, search screen 900 may be a variation of search screen 100. In another aspect, search screen 900 and search screen 100 may transition to each other.

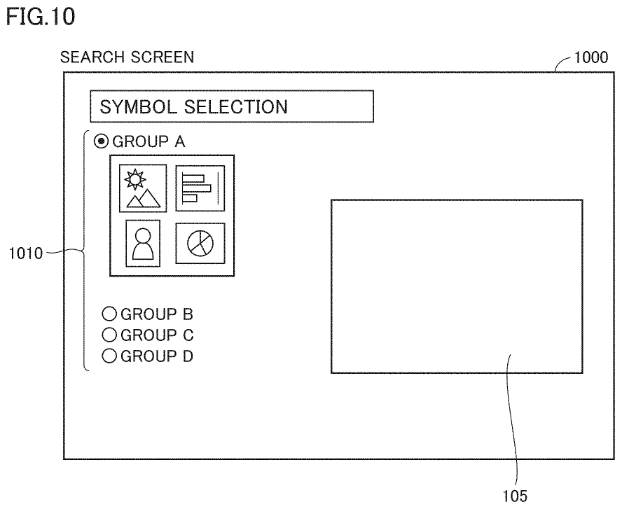

FIG. 10 is a view illustrating a fifth example of the function of document search system 200. A search screen 1000 has a function for producing a user-defined group 1010 and a function for displaying symbol 120 included in user-defined group 1010. The user can group at least one arbitrary symbol 120 through search screen 1000. For example, the user can group a plurality of symbols 120 frequently used on own business through search screen 1000.

In one aspect, terminal 220 may transmit the information about the user-defined group to search server 210. In this case, search server 210 can distribute the search screen including the information about the user-defined group to terminal 220 next time or later.

In another aspect, each search screen may have a function for switching whether to display each of at least one symbol individually or in units of groups. For example, each search screen may include the radio button switching on and off of the display for each group, or may include the radio button switching on and off of the display for each individual symbol 120.

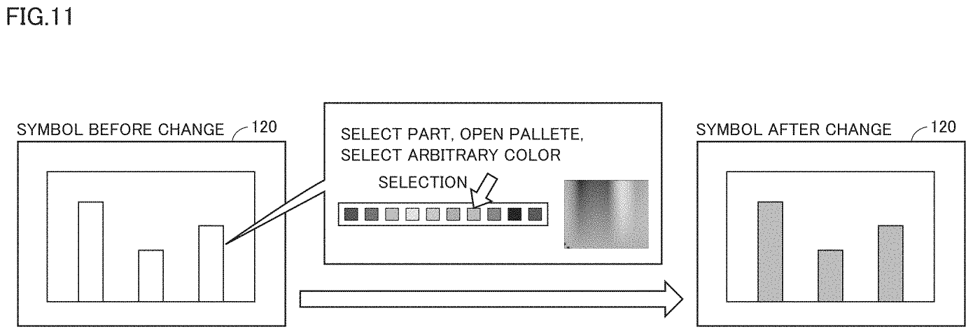

FIG. 11 is a view illustrating a sixth example of the function of document search system 200. The user can change the color of symbol 120 on an arbitrary search screen. In the example of FIG. 11, the user changes the color of symbol 120 using a palette tool or the like. Terminal 220 reflects the color change of symbol 120 in the setting item of symbol 120 in the search condition.

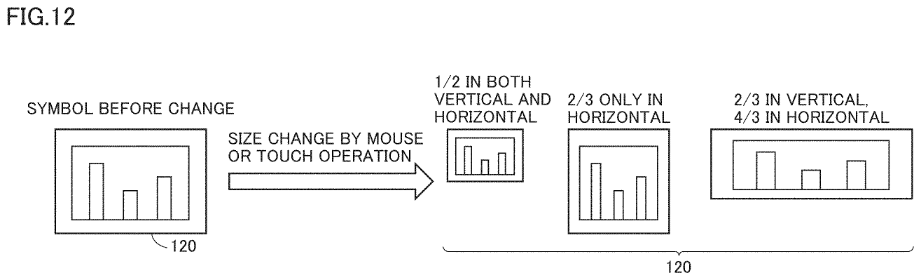

FIG. 12 is a view illustrating a seventh example of the function of document search system 200. The user can change the size or the aspect ratio of symbol 120 on an arbitrary search screen. In the example of FIG. 12, the user changes the aspect ratio of symbol 120 by the mouse, the touch operation, or the like. Terminal 220 reflects the change in the size or ratio of symbol 120 in the setting item of symbol 120 in the search condition.

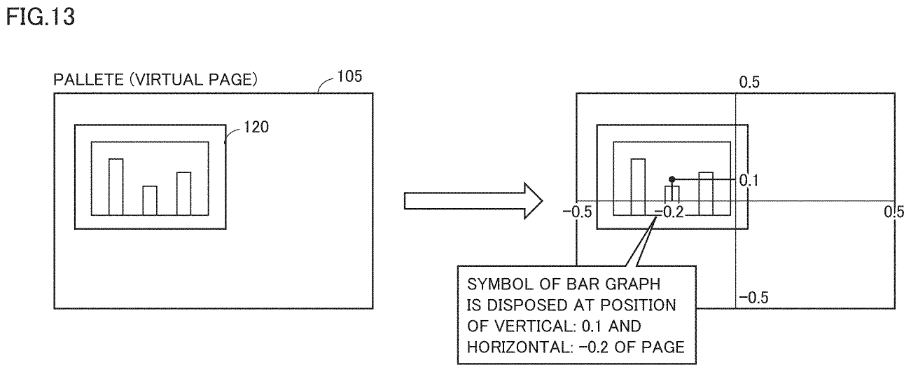

FIG. 13 is a view illustrating an eighth example of the function of document search system 200. Terminal 220 executing the Javascript program or the like of the search screen 100 or the like to calculate the relative position of symbol 120 with respect to virtual page 105. Terminal 220 may include the relative position in the search condition. In the example of FIG. 13, terminal 220 calculates a center coordinate of symbol 120 with respect to a center coordinate of virtual page 105. Terminal 220 may use the coordinates or the like of vertexes of virtual page 105 and symbol 120 for the calculation of the relative position. Terminal 220 reflects the relative position of symbol 120 in the setting item of symbol 120 in the search condition.

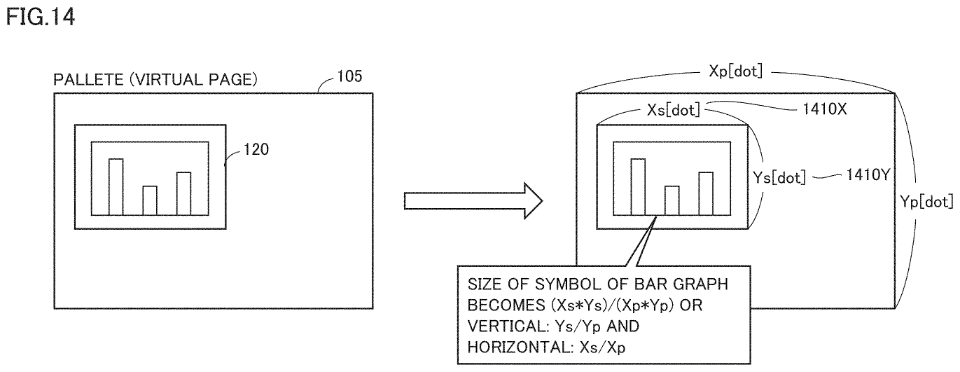

FIG. 14 is a view illustrating a ninth example of the function of document search system 200. Terminal 220 executing the Javascript program or the like of search screen 100 or the like to calculate the relative area or the ratio of the vertical and horizontal sides of symbol 120 with respect to virtual page 105. Terminal 220 may include the relative area or the ratio of the vertical and horizontal sides in the search condition. In the example of FIG. 14, terminal 220 compares the sizes in the X-axis direction and the Y-axis direction of virtual page 105 with the sizes in the X-axis direction and the Y-axis direction of symbol 120. Terminal 220 reflects the relative area or the ratio of the vertical and horizontal sides of symbol 120 in the setting item of symbol 120 under the search condition.

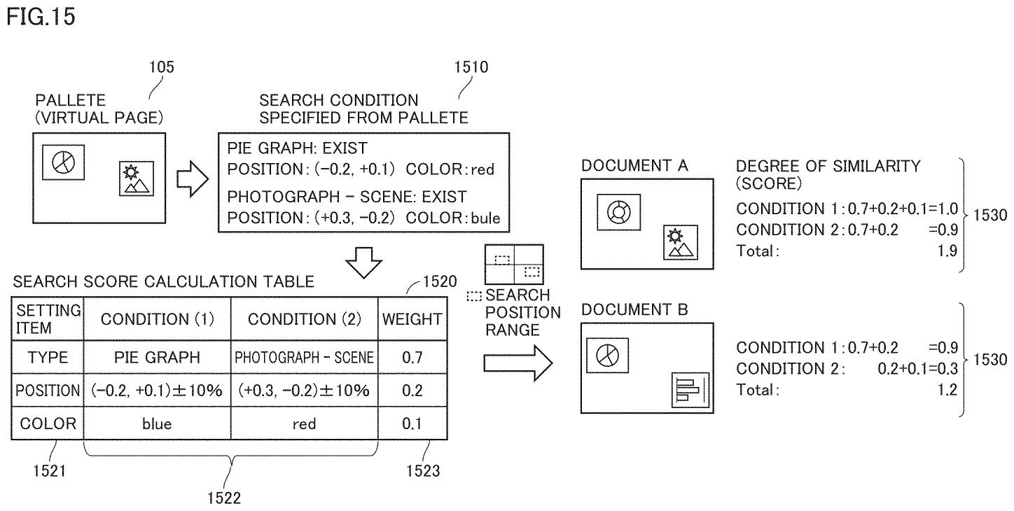

FIG. 15 is a view illustrating a tenth example of the function of document search system 200. With reference to FIG. 15, the detailed calculation of the degree of similarity of the document by document search system 200 will be described. Terminal 220 generates a search condition 1510 from virtual page 105 on which symbol 120 is disposed. The search condition includes the setting item (some or all of any items such as the type, the position, the size, the color, and the like) of each symbol 120.

Subsequently, search server 210 generates a search score calculation table 1520 based on search condition 1510 acquired from terminal 220. Search score calculation table 1520 can be expressed in an arbitrary data format.

As an example, search score calculation table 1520 includes a setting item 1521 of symbol 120, a condition 1522, and a weight (coefficient) 1523. Setting item 1521 corresponds to the setting item (some or all of any items such as the type, the position, the size, the color, and the like) of symbol 120 included in the search condition. Condition 1522 corresponds to each symbol 120 included in the search condition. Condition 1522 exists as many as the number of symbols 120 included in the search condition. Weight (coefficient) 1523 is a coefficient or a score of each setting item when the degree of similarity is calculated.

Subsequently, search server 210 compares search score calculation table 1520 with index 510 to calculate the degree of similarity of each document. In the example of FIG. 15, search server 210 finds documents A, B as the document satisfying at least a part of a condition (1) (pie graph) and a condition (2) (photograph-landscape). In this case, search server 210 calculates a degree of similarity 1530 between documents A, B in the following procedure.

It is assumed that all the items (the type, the position, the color) of the pie graph of document A are matched with the setting items (the type, the position, the color) of condition (1) (pie graph). In this case, the score of condition (1) of document A is “0.7+0.2+0.1=1.0”. It is assumed that the item (the type, the position) of the picture-landscape of document A is matched with the setting item (the type, the position) of condition (2) (picture-landscape), but it is assumed that the item (color) of the picture-landscape of document A is not matched with the setting item (color) of condition (2) (picture-landscape). In this case, the score of condition (2) of document A becomes “0.7+0.2=0.9”. The degree of similarity 1530 of document A becomes a sum “1.0+0.9=1.9” of the scores of the respective conditions included in search score calculation table 1520. The degree of similarity 1530 of document B is also calculated in the similar procedure.

In one aspect, document search system 200 may not use the weight (coefficient). In this case, document search system 200 may calculate the degree of similarity by equalizing the score of each item.

In one aspect, terminal 220 may executing the Javascript program or the like of search screen 100 or the like to generate search score calculation table 1520. In this case, terminal 220 transmits search score calculation table 1520 to search server 210 instead of search condition 1510.

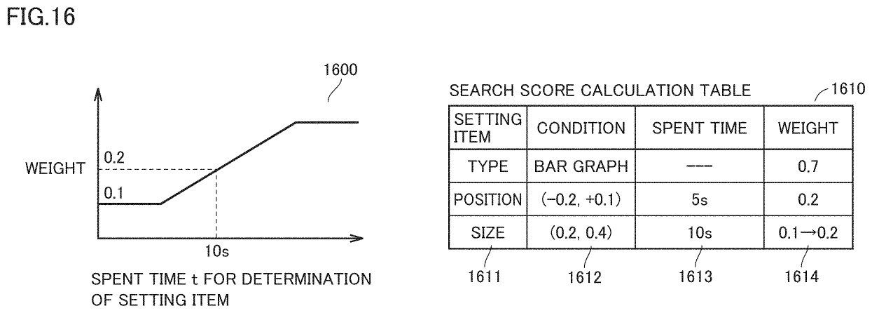

FIG. 16 is a view illustrating an eleventh example of the function of document search system 200. Document search system 200 can adjust the weight (coefficient) for each setting item of symbol 120 based on the time taken by the user to determine the setting item of symbol 120.

A graph 1600 illustrates a relationship between the time spent by the user to determine the setting item of symbol 120 and the weight (coefficient) of the setting item of symbol 120. From graph 1600, it can be seen that the value of the weight of the setting item of symbol 120 increases as the time spent by the user to determine the setting item of symbol 120 increases. This is because there is a high possibility that the setting item determined by the user over a long time is an important setting item.

Search server 210 can store a parameter changing the weight (coefficient) for each setting item of symbol 120 in secondary storage device 3 based on the time required for the user to determine the setting item of symbol 120.

Terminal 220 generates the search condition from virtual page 105 on which symbol 120 is disposed. The search condition includes the setting item (some or all of any items such as the type, the position, the size, the color, and the like) of each symbol 120 and the time required to determine the setting item of each symbol 120.

Search server 210 generates a search score calculation table 1610 based on the search conditions acquired from terminal 220. As an example, search score calculation table 1610 includes a setting item 1611 of symbol 120, a condition 1612, a spent time 1613, and a weight (coefficient) 1614.

Setting item 1611 corresponds to the setting item (some or all of any items such as the type, the position, the size, the color, and the like) of symbol 120 included in the search condition. Condition 1612 corresponds to each symbol 120 included in the search condition. Condition 1612 may exist as many as the number of symbols 120 included in the search condition. Spent time 1613 is the time spent by the user to determine the setting item of symbol 120. Weight (coefficient) 1614 is a coefficient or a score of each setting item when the degree of similarity is calculated. Search server 210 determines a value of weight 1614 based on spent time 1613. There is a possibility that some setting items 1611 (the type, the position, and the like) may not take time to determine but may be required. Accordingly, in one aspect, the value of weight 1614 of some setting items 1611 may be constant regardless of spent time 1613.

Search server 210 compares search score calculation table 1610 with index 510 to calculate the degree of similarity of each document. A method for calculating the degree of similarity of each document is as illustrated in FIG. 15.

In one aspect, terminal 220 may generate search score calculation table 1610 by executing the Javascript program or the like of search screen 100 or the like. In this case, terminal 220 transmits search score calculation table 1610 to search server 210 instead of the search condition.

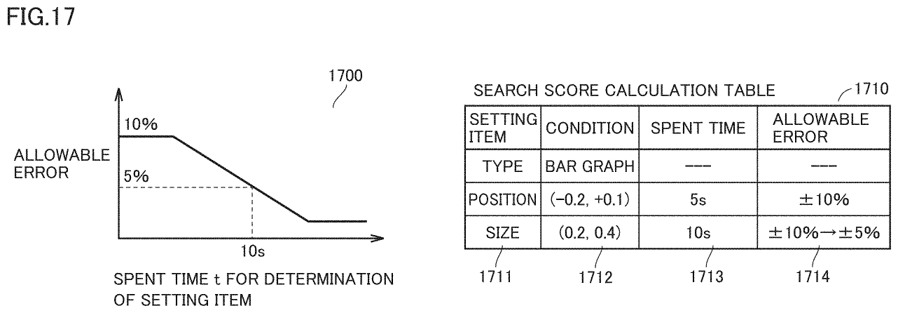

FIG. 17 is a view illustrating a twelfth example of the function of document search system 200. Document search system 200 can adjust an allowable error of each symbol 120 based on the time required to set the setting item of symbol 120. The “allowable error” indicates an allowable error (threshold) when it is determined whether the item of the object in the document is matched with the setting item of symbol 120 included in the search condition.

A graph 1700 illustrates a relationship between the time spent by the user to determine the setting item of symbol 120 and the allowable error of symbol 120. It can be seen that the longer the time the user spends in determining the setting item of symbol 120, the smaller the value of the allowable error of symbol 120. This is because there is a possibility that the setting item determined by the user over a long time is set in more detail in a form closer to the item of the object included in the document to be searched, and it is considered that the value of the allowable error is desirably small in order to reduce noise.

Search server 210 can store a parameter changing the allowable error for each setting item of symbol 120 in secondary storage device 3 based on the time required for the user to determine the setting item of symbol 120.

Terminal 220 generates the search condition from virtual page 105 on which symbol 120 is disposed. The search condition includes the setting item (some or all of any items such as the type, the position, the size, the color, and the like) of each symbol 120 and the time required to determine the setting item of each symbol 120.

Search server 210 generates a search score calculation table 1710 based on the search conditions acquired from terminal 220. As an example, search score calculation table 1710 includes a setting item 1711 of symbol 120, a condition 1712, a spent time 1713, and a weight (coefficient) 1714.

Setting item 1711 corresponds to the setting item (some or all of any items such as the type, the position, the size, the color, and the like) of symbol 120 included in the search condition. Condition 1712 corresponds to each symbol 120 included in the search condition. Condition 1712 may exist as many as the number of symbols 120 included in the search condition. Spent time 1713 is the time spent by the user to determine the setting item of symbol 120. Allowable error 1714 indicates the allowable error of the setting item of symbol 120. For example, the allowable error of the setting item “position” in FIG. 17 is 10%. In this case, search server 210 determines that the object is matched with the search condition (position) even when the position (coordinates) of symbol 120 and the position of the object are shifted by 10%. Search server 210 determines the value of allowable error 1714 based on spent time 1713. In one aspect, the value of allowable error 1714 of some setting items 1711 may be constant regardless of spent time 1713.

Search server 210 compares search score calculation table 1710 with index 510 to calculate the degree of similarity of each document. A method for calculating the degree of similarity of each document is as illustrated in FIG. 15.

In one aspect, terminal 220 may generate search score calculation table 1710 by executing the Javascript program or the like of search screen 100 or the like. In this case, terminal 220 transmits search score calculation table 1710 to search server 210 instead of the search condition.

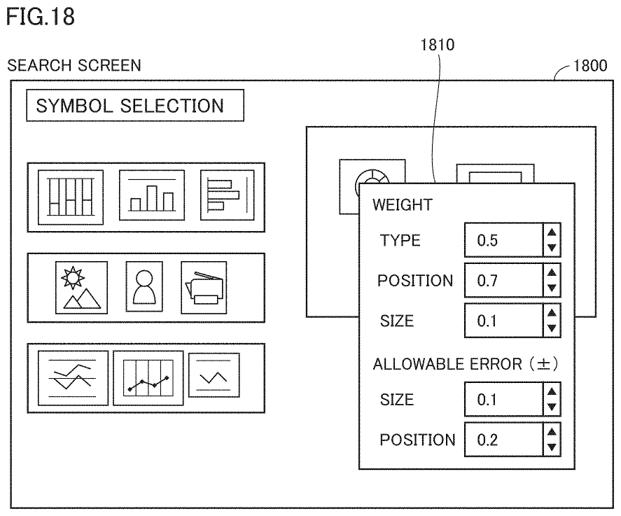

FIG. 18 is a view illustrating a thirteenth example of the function of document search system 200. A search screen 1800 is a screen manually setting the weight and the allowable error for each setting item of each symbol 120. The user can set the weight and the allowable error of each setting item (the type, the position, the size, and the like) through search screen 1800. In one aspect, search screen 1800 may include a dialog 1810 setting the weight and the allowable error. The search condition includes the weight and the allowable error of each setting item set on search screen 1800. Terminal 220 reflects the weight and the allowable error of each setting item input by the user in the search condition. In one aspect, search screen 1800 may be the variation of search screen 100. In another aspect, search screen 1800 and search screen 100 may transition to each other.

When the search condition includes the weight and the allowable error of each setting item input by the user, search server 210 generates the search score calculation table using the weight and the allowable error. When the search condition does not include the weight and the allowable error of each setting item input by the user, search server 210 generates the search score calculation table by the method in FIGS. 15 to 17 or a combination thereof.

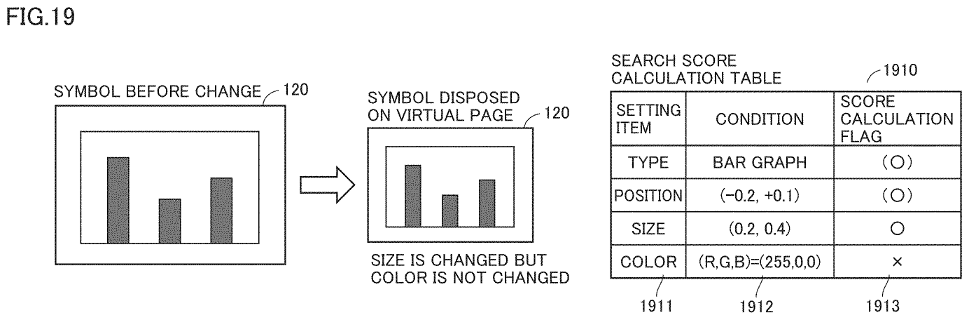

FIG. 19 is a view illustrating a fourteenth example of the function of document search system 200. Document search system 200 may determine whether each setting item is used to calculate the degree of similarity (score) based on whether the user manually changes the setting item of symbol 120.

As described with reference to FIGS. 11 to 14, the user can manually change the setting item (the color, the size, and the like) of each symbol from the default setting on the search screen. Terminal 220 generates the search condition from virtual page 105 on which symbol 120 is disposed. The search condition includes the setting item (some or all of any items such as the type, the position, the size, the color, and the like) of each symbol 120.

Search server 210 generates a search score calculation table 1910 based on the search conditions acquired from terminal 220. As an example, search score calculation table 1910 includes a setting item 1911 of symbol 120, a condition 1912, and a score target flag 1913.

Setting item 1911 corresponds to the setting item (some or all of any items such as the type, the position, the size, the color, and the like) of symbol 120 included in the search condition. Condition 1912 corresponds to each symbol 120 included in the search condition. Condition 1912 may exist as many as the number of symbols 120 included in the search condition. Score target flag 1913 indicates whether to be used for the calculation of the degree of similarity.

Search server 210 may change score target flag 1913 such that the setting item manually changed by the user is used for the calculation of the degree of similarity (score target flag=∘), and may change score target flag 1913 such that the setting item not manually changed by the user (default setting item) is not used for the calculation of the degree of similarity (score target flag=x). This is because there is a high possibility that the setting item (the setting item that is not the default setting) manually changed by the user is required. In one aspect, search server 210 may always use some of setting items 1911 (the type, the position, and the like) for the calculation of the degree of similarity.

Search server 210 compares search score calculation table 1610 with index 510 to calculate the degree of similarity of each document. A method for calculating the degree of similarity of each document is as illustrated in FIG. 15.

In one aspect, terminal 220 may generate search score calculation table 1910 by executing the Javascript program or the like of search screen 100. In this case, terminal 220 transmits search score calculation table 1910 to search server 210 instead of the search condition.

Search server 210 may use a part or all of the methods illustrated in FIGS. 15 to 19 in combination. For example, search server 210 may generate the search score calculation table including all or part of the time spent to determine each setting item, the weight (coefficient) of each setting item, the allowable error of each setting item, and the score target flag.

In one aspect, terminal 220 may execute the Javascript program or the like of search screen 100 or the like to generate the search score calculation table including all or part of the time spent to determine each setting item, the weight (coefficient) of each setting item, the allowable error of each setting item, and the score target flag. In this case, terminal 220 transmits the generated search score calculation table to search server 210 instead of the search condition.

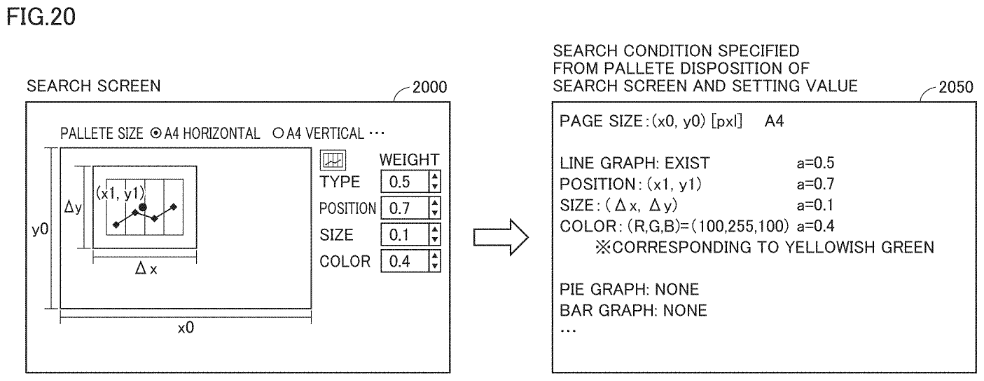

FIG. 20 is a view illustrating a fifteenth example of the function of document search system 200. A search screen 2000 is a screen manually setting the size of virtual page 105, setting items (the color, the size, and the like) of each symbol, and the weight and the allowable error for each setting item of each symbol 120. The user can change the size of the virtual page 105, each setting item, the weight of each setting item, and the allowable error of each setting item through search screen 2000. Terminal 220 reflects the change in the size of the virtual page 105, the change in each setting item, the change in the weight of each setting item, and the change in the allowable error of each setting item that are input by the user in a search condition 2050. Search server 210 can generate the search score calculation table and perform the search processing using received search condition 2050.

In one aspect, the search screen may include an arbitrary UI appropriately combining and using some or all of the functions described with reference to FIGS. 1 to 20. In another aspect, document search system 200 may use some or all of the functions described with reference to FIGS. 1 to 20 in combination as appropriate. Furthermore, in another aspect, either terminal 220 or search server 210 may generate the search score calculation table from the search conditions.

### D. Flowchart of Processing of Document Search System

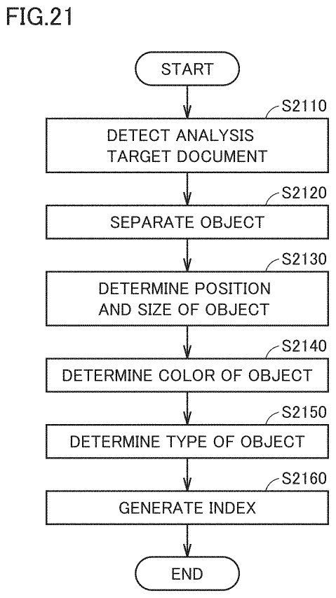

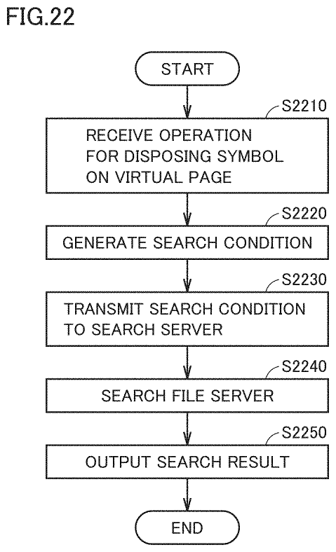

With reference to FIGS. 21 and 22, a flowchart of processing of document search system 200 will be described below. In one aspect, in order to execute the processing in FIGS. 21 and 22, search server 210 and CPU 1 of terminal 220 may read the program executing the processing in FIGS. 21 and 22 from secondary storage device 3 to primary storage device 2 to execute the program. In another aspect, a part or all of the processing can be implemented as a combination of circuit elements configured to execute the processing.

FIG. 21 is a flowchart illustrating an example of processing of generating index 510 by search server 210. In step S2110, search server 210 detects the analysis target document. In one aspect, search server 210 may periodically acquire a newly added document from file server 230. In another aspect, search server 210 may detect the document added by terminal 220 to file server 230 or the document edited by terminal 220 on file server 230 as the analysis target document.

In step S2120, search server 210 separates the object. More specifically, search server 210 analyzes the document and separates the figure, the graph, and the like included in the document into units of objects.

In step S2130, search server 210 determines the position and the size of the object. In step S2140, search server 210 determines the color of the object. In step S2150, search server 210 determines the type of the object.

In step S2160, search server 210 generates index 510. Index 510 includes at least one setting item (the type, the color, the position, the size, and the like) of each of at least one object included in the document. Search server 210 stores index 510 in secondary storage device 3.

FIG. 22 is a flowchart illustrating an example of search processing by search server 210 and terminal 220. In step S2210, terminal 220 receives the operation for disposing symbol 120 on virtual page 105. More specifically, terminal 220 receives the operation for disposing symbol 120 on virtual page 105 from the user through search screen 100 or the like.

In step S2220, terminal 220 generates the search condition. More specifically, terminal 220 generates the search condition based on virtual page 105 in which symbol 120 is disposed. In step S2230, terminal 220 transmits the search condition to search server 210. In one aspect, terminal 220 may transmit the search score calculation table generated from the search condition to search server 210 instead of the search condition. In step S2240, search server 210 searches file server 230 by referring to the search condition and index 510. In the search processing, search server 210 generates a search score calculation table from the search condition and calculates the degree of similarity of the document. In step S2250, search server 210 outputs the search result. More specifically, search server 210 transmits the search result including the information, thumbnails, and the like of one or the plurality of documents matched with the search condition to terminal 220.

As described above, document search system 200 of the embodiment has a function for disposing symbol 120 associated with the type of the object on virtual page 105. With this function, the user can faithfully and easily reproduce the image of the search target document in the mind on virtual page 105. In addition, document search system 200 generates the search condition based on virtual page 105 on which the symbol 120 is disposed, so that the document in file server 230 can be searched for based on the feature amount of the document.

Although embodiments of the present invention have been described and illustrated in detail, the disclosed embodiments are made for purposes of illustration and example only and not limitation. The scope of the present invention should be interpreted by terms of the appended claims. The scope of the present invention is indicated by the claims, and it is intended that all modifications within the meaning and scope of the claims are included in the present invention.

What is claimed is:

1. A document search system comprising:
a storage that stores at least one index, each of the at least one index including a feature amount relating to at least one object included in each of at least one document stored in a file server; and
a controller that refers to the at least one index to search for the at least one document stored in the file server,
wherein the controller
causes a terminal to display a search screen, the search screen having a function for disposing each of at least one symbol associated with each of a type of the at least one object on a virtual page representing the document, and
searches for a document matched with a search condition from among the at least one document stored in the file server by referring to the search condition including disposition information about the at least one symbol on the virtual page and the at least one index based on an operation of the search screen.

2. The document search system according to claim 1, wherein each of the feature amount includes information relating to a type, a position, a size, and a color of each of the at least one object.

3. The document search system according to claim 1, wherein the search screen has a function for selecting or designating a size of the virtual page.

4. The document search system according to claim 1, wherein each of the at least one symbol is grouped for each type of the at least one object, and
the search screen has a function for displaying a part of the at least one symbol in units of groups.

5. The document search system according to claim 4, wherein the search screen has a function for switching whether to display each of the at least one symbol individually or in units of groups.

6. The document search system according to claim 4, wherein the search screen has a function for grouping the symbol selected from among the at least one symbol based on an operation of a user and displaying the grouped symbol.

7. The document search system according to claim 1, wherein the search screen has a function for displaying a symbol having a high use frequency from among the at least one symbol based on a past use history of the at least one symbol.

8. The document search system according to claim 3, wherein the search screen has a function for changing a color of the at least one symbol.

9. The document search system according to claim 3, wherein the search screen has a function for changing a size of the at least one symbol.

10. The document search system according to claim 3, wherein the search screen has a function for generating the search condition from the virtual page on which the at least one symbol is disposed, and
the search condition includes a relative position of each of the at least one symbol disposed on the virtual page with respect to the virtual page.

11. The document search system according to claim 3, wherein the search screen has a function for generating the search condition from the virtual page on which the at least one symbol is disposed, and
the search condition includes a relative area of the at least one symbol disposed on the virtual page with respect to the virtual page.

12. The document search system according to claim 1, wherein the search condition includes a setting item of each of the at least one symbol, and
the controller
sets a coefficient of each setting item based on reception of the search condition, and
compares the search condition with each of the at least one index, and calculates the degree of similarity of a search target document based on a total value of each coefficient of the setting item matched between the search condition and each of the at least one index.

13. The document search system according to claim 12, wherein the controller
sets an allowable error indicating a range in which the setting item is considered to be matched during comparison between the search condition and each of the at least one index in each setting item based on reception of the search condition, and
compares the search condition with each of the at least one index to determine whether there is the setting item that is matched within the range of the allowable error.

14. The document search system according to claim 13, wherein the setting item includes at least one of a type, a position, a size, and a color of each of the at least one symbol.

15. The document search system according to claim 12, wherein the controller increases a value of the coefficient of the setting item based on an increase in time required for a user to designate the setting item.

16. The document search system according to claim 12, wherein the controller decreases a value of the allowable error of the setting item based on an increase in time required for a user to designate the setting item.

17. The document search system according to claim 13, wherein the search screen has a function for receiving input of the coefficient and the allowable error for each of the setting item and including the input coefficient and allowable error in the search condition, and
the controller executes search processing using the coefficient and the allowable error included in the search condition.

18. The document search system according to claim 12, wherein the controller determines whether each of the setting item is used for calculation of the degree of similarity based on whether the setting item included in the search condition is changed from a default setting.

19. A document search method by a computer, the document search method comprising:
storing at least one index searching for at least one document stored in a file server, each of the at least one index including a feature amount relating to at least one object included in each of the at least one document stored in the file server;
causing a terminal to display a search screen, the search screen having a function for disposing each of at least one symbol associated with each of a type of the at least one object on a virtual page representing the document; and
searching for a document matched with a search condition from among the at least one document stored in the file server by referring to the search condition including disposition information about the at least one symbol on the virtual page and the at least one index based on an operation of the search screen.

20. A computer-readable storage medium in which a document search program that causes a computer to execute the document search method according to claim 19 is stored.
